(19) United States
(12) Patent Application Publication
(10) Pub. No.: US 2024/0143777 A1
(43) Pub. Date: May 2, 2024

(54) INSTRUMENTING OBSERVABILITY CONTROLS

(71) Applicant: Cisco Technology, Inc., San Jose, CA (US)

(72) Inventors: Ashish Kundu, San Jose, CA (US); Ramana Rao V. R. Kompella, Cupertino, CA (US)

(21) Appl. No.: 17/977,193

(22) Filed: Oct. 31, 2022

(51) Int. Cl. G06F 21/57; G06F 21/54; G06F 21/55

(52) U.S. Cl. CPC G06F 21/577; G06F 21/54; G06F 21/552

(57) ABSTRACT

In one embodiment, a device may identify one or more vulnerable portions of a program to be observed based on security vulnerability information. The device may instrument the program with an observability control to configure collecting of observability information regarding the one or more vulnerable portions of the program. The device may modify the observability control based on one or more attributes associated with the collecting of the observability information regarding the one or more vulnerable portions of the program. The device may the observability information regarding the one or more vulnerable portions of the program according to the observability control as modified.

### TECHNICAL FIELD

The present disclosure relates generally to computer systems, and, more particularly, to instrumenting observability controls.

### BACKGROUND

Modern software programs used by businesses and consumers alike are packed with functionalities. The functionalities of the programs are achieved by executing instructions written in the code of the software program. These functionalities are largely implemented by reusing portions of existing code segments and/or coding approaches from external sources (e.g., open source, other developers' work, etc.) and/or from a developer's own past projects. As such, the same code and/or coding approaches may be present across a variety of software programs. This approach facilitates a rapid, reliable, and consistent process of code development, which also affords standardized resource access, interoperability, standardized syntaxes, etc.

However, reliance on same or similar coding across software programs can translate to the presence of same or similar vulnerabilities across software programs. Too often, preventable exploits of known vulnerabilities occur due to lack of knowledge that the vulnerability is present in the code of a software program and/or a lack of visibility of observability data from vulnerable portions of the code.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example architecture for instrumenting observability controls;

FIG. 5 illustrates example operations for instrumenting observability controls by an observability control instrumenting manager;

FIG. 6 illustrates example operations of observability attributes for modifying an observability control; and

FIG. 7 illustrates an example simplified procedure for instrumenting observability controls in accordance with one or more embodiments described herein.

### DESCRIPTION OF EXAMPLE EMBODIMENTS

### Overview

According to one or more embodiments of the disclosure, an illustrative method herein may comprise: identifying, by a device, one or more vulnerable portions of a program to be observed based on security vulnerability information; instrumenting, by the device, the program with an observability control to configure collecting of observability information regarding the one or more vulnerable portions of the program; modifying, by the device, the observability control based on one or more attributes associated with the collecting of the observability information regarding the one or more vulnerable portions of the program; and collecting, by the device, the observability information regarding the one or more vulnerable portions of the program according to the observability control as modified.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

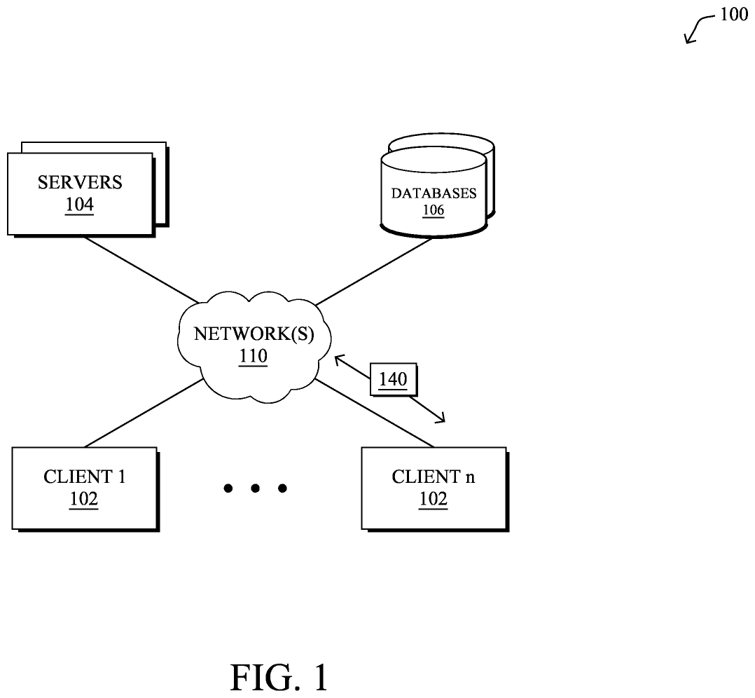

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

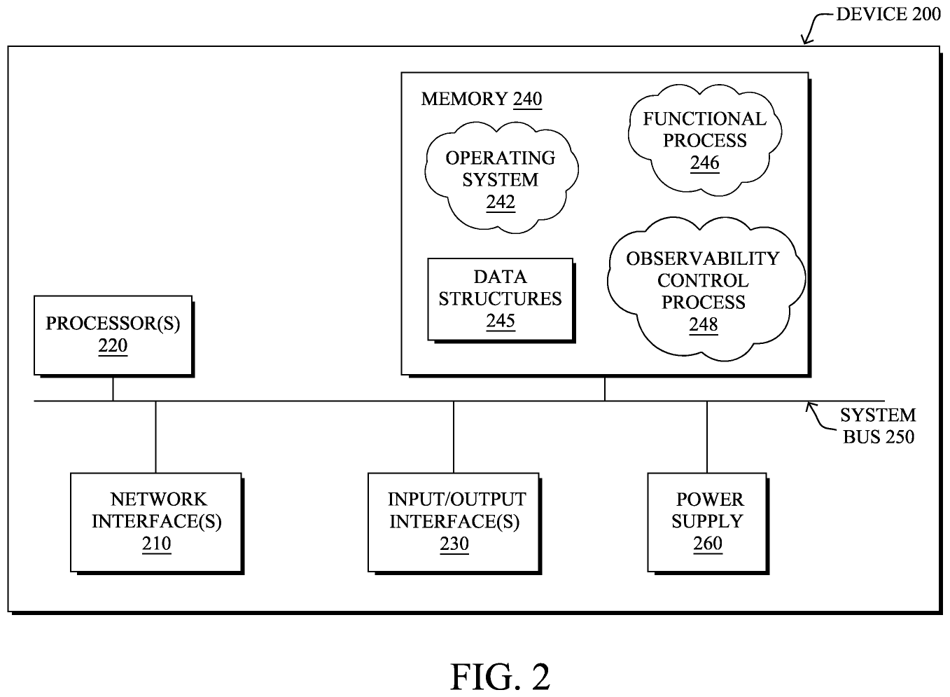

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “observability control” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

—Observability Intelligence Platform —

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

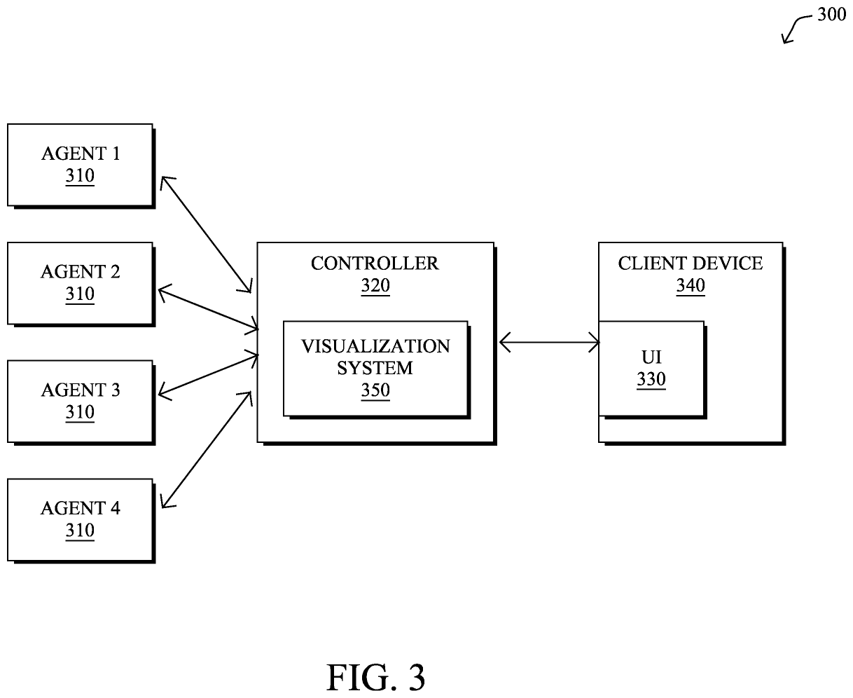

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance 320 may be hosted remotely by a provider of the observability intelligence platform 300. In an illustrative on-premises (On-Prem) implementation, a controller instance 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

—Instrumenting Observability Controls —

As noted above, the presence of same or similar coding across software programs can result in the presence of same or similar vulnerabilities across software programs. Vulnerabilities in software programs can include flaws in the coding that weakens or leaves the program exposed to exploitation through an attack vector. Often, when the vulnerability is discovered in a software program, there is a lack of awareness of its presence in other software programs given the complexity of tracking code use and reuse across programs. In addition, fuzzing and testing of a software program may not uncover these vulnerabilities in the code due to aliasing, dynamic typing, and/or a host of other complicating issues.

Observability information collected during the execution of a program may reveal abnormal issues in a program. However, the collection, processing, storing, and logging of observability information may impose a cost to the program, a host network/system, etc. An example of a cost imposed by observability information collection, processing, storing, logging, etc. may include and/or be quantifiable by an amount of computational resources, an amount of network bandwidth, an amount of storage, an amount of performance degradation, an amount of money (e.g., to maintain the aforementioned resources), etc. Due to these costs, developers may be selective regarding the observability data collected and/or processed for a given application. As a result, vulnerable portions of the code and/or their functionalities may not be instrumented with observability tools to monitor their operation. Therefore, preventable exploits of known vulnerabilities may occur for a program due to lack of knowledge that the vulnerability is present in the code of that program and/or due to a lack of visibility of observability data from the vulnerable portions of the code.

In contrast, the techniques herein introduce mechanisms to automatically identify vulnerable portions of a software program (e.g., application software, system software, firmware, etc.) and instrument that program with observability controls to dynamically configure the collection of observability information from those vulnerable portions. The observability controls can be activated, deactivated, and otherwise modified to adjust the degree of observability information (e.g., metrics, events, logs, telemetry, etc.) collected with respect to the vulnerable portions of the program. In various embodiments, vulnerable code segments, vulnerable components of a system, vulnerable communication paths may be determined from other mechanisms and may be specified as a configuration or as part of a dynamically updated list. The observability control systems may take the list as an input and provide the instrumentation of the system for observability of the vulnerable components or to reduce observability when vulnerable channels or components are used for collection of observability data.

Illustratively, the techniques described herein may be performed by hardware, software, and/or firmware, such as in accordance with observability control process 248, which may include computer executable instructions executed by the processor 220 (or independent processor of interfaces 210) to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the observability control process 248.

Operationally and according to various embodiments, the techniques herein provide an ability to equip a software program with the functionality to adjustably log observability information for vulnerable portions of the program, which can be implemented to selectively apply different levels of analysis to the behavior of vulnerable portions of the program based on a variety of factors including policies and/or dynamic risk assessments.

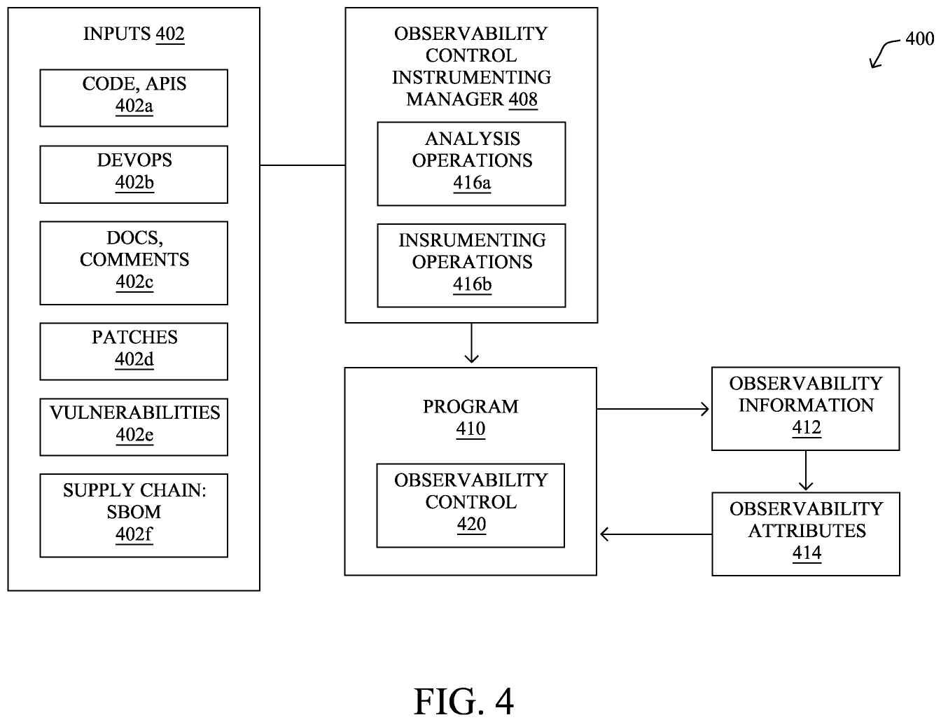

Specifically, FIG. 4 illustrates an example architecture 400 for instrumenting observability controls, according to various embodiments. Architecture 400 may include an observability control instrumenting manager 408. Observability control instrumenting manager 408 may be utilized to manage the instrumentation of a program 410 with an observability control 420.

Program 410 may include a software program. Program 410 may include application software, system software, firmware, etc. Program 410 may include application programming interfaces (APIs), libraries, databases, etc. Program 410 may be distributed and/or cloud-based and provide access to application software and databases over a network.

The execution of program 410 may be monitored and observability information may be collected from its execution. The observability information may be utilized to monitor the activity of various portions of program 410 and to ensure that those portions are operating in an expected and/or non-compromised manner.

Observability control instrumenting manager 408 may obtain and/or process any number of inputs 402 to instrument observability control 420. In various embodiments, inputs 402 may include information about program 410 and/or security vulnerability information related to known security vulnerabilities outside and/or within program 410.

For example, a first input 402a may include code associated with program 410. In some instances, this may include binaries of libraries of program 410 and/or the program source code/binaries of program 410. First input 402a may include code associated with APIs of program 410. Additionally, first input 402a may also include information associated with data flow and control flow paths of program 410.

A second input 402b may include DevOps information related to program 410. For example, second input 402b may include the status of program 410 in a DevOps development process. In some instances, DevOps information may include code developed and/or tested by a same team of developers of a similar team of developers within a DevOps process. DevOps information may provide information regarding the development process of program 410.

A third input 402c may include code documentation and/or code comments related to program 410. For example, third input 402c may include meta text and/or inline comments in the code of program 410. Additional examples may include high-level documentation explaining flows, patterns, overviews, guidelines, and functional perspective on the codebase of program 410.

A fourth input 402d may include software patch information related to program 410. Software patch information may include code of the software patches available to be applied and/or already applied to program 410. Software patch information may include information regarding the status of implementation and/or testing of the software patches and/or whether those software patches are stable.

A fifth input 402e may include known vulnerabilities. Known vulnerabilities may include a catalog of known exploited and/or suspected vulnerabilities and/or any identifying information of those vulnerabilities which may be used to identify their presence in program 410. For example, the known vulnerabilities may include the code, coding strategies, communication paths, attack vectors, untrustworthy agents, compromised cryptographic and security information, insecure designs, security misconfigurations, outdated components, etc. associated with known vulnerabilities. The known vulnerabilities may include vulnerabilities that were detected, patched, and/or remediated in the code of program 410 and/or in other code developed and/or tested by the same or similar team of developers. The known vulnerabilities may also include risk levels and other analytics associated with each of the known vulnerabilities and/or their exploitation.

A sixth input 402f may include software supply chain and/or software bill of materials “SB OM” for program 410. For example, sixth input 402f may include an inventory of all constituent components and software dependencies involved in the development and delivery of program 410. In some instances, this may include a vulnerability-exploitability exchange (VEX) for program 410 including information about whether program 410 is impacted by specific vulnerabilities and what remediation actions are recommended for specific vulnerabilities.

Observability control instrumenting manager 408 may instrument program 410 with an observability control 420 based on inputs 402. In various embodiments, observability control instrumenting manager 408 may utilize static and/or dynamic analysis, analytics, artificial intelligence (AI), machine learning (ML), etc. to process inputs 402 and derive an instrumentation plan to instrument program 410 with an observability control 420.

For example, observability control instrumenting manager 408 may employ any number of machine learning techniques, such as to classify the collected data from inputs 402 and to cluster the data as described herein. In general, machine learning is concerned with the design and the development of techniques that receive empirical data as input (e.g., collected metric/event data from agents, sensors, inputs 402, etc.) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, the techniques herein can use the model M to classify new data points. Often, M is a statistical model, and the cost function is inversely proportional to the likelihood of M, given the input data.

One class of machine learning techniques that is of particular use herein is clustering. Generally speaking, clustering is a family of techniques that seek to group data according to some typically predefined or otherwise determined notion of similarity.

Also, the performance of a machine learning model can be evaluated in a number of ways based on the number of true positives, false positives, true negatives, and/or false negatives of the model.

In various embodiments, such techniques may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may attempt to analyze the data without applying a label to it. Semi-supervised learning models take a middle ground approach that uses a greatly reduced set of labeled training data.

Example machine learning techniques that the techniques herein can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like. These techniques and others may be utilized by observability control instrumenting manager 408 to process inputs 402 and perform operations to identify vulnerable portions of program 410 and to instrument an observability control 420 based on those inputs 402. For example, observability control instrumenting manager 408 may use these techniques to perform operations such as analysis operations 416a and/or instrumenting operations 416b to instrument the vulnerable portions of program 410 with an observability control 420.

Analysis operations 416a may include operations that utilize inputs 402 to identify vulnerabilities in program 410. For example, analysis operations 416a may include using knowledge of known vulnerabilities, gained from inputs 402, to identify potentially vulnerable portions of program 410. For instance, analysis operations 416a may include analyzing the code of program 410 to determine portions of program 410 where the same or similar vulnerabilities may exist.

Instrumenting operations 416b may include determining portions, such as potentially vulnerable portions, of program 410 that should be instrumented with an observability control 420. This determination may be based on various inputs 402. For example, performing instrumenting operations 416b may include optimizing instrumentation of the portions of the program 410 based on various inputs 402. Optimizing instrumentation may include planning where and when to implement each observability control 420 so that a balance is maintained between the criticality of the observation of particular portions of program 410 and the cost associated with making that observation. For example, a relatively low-risk potential vulnerability, a potential vulnerability that consistently generates a relatively small amount of observability, a potential vulnerability for which observability information is not available and/or would not be helpful, etc. may not warrant the instrumentation of a corresponding observability control.

Instrumenting operations 416b may include instrumenting program 410 with an observability control 420 based on the above-described determinations of the portions of program 410 to be instrumented with an observability control 420. The observability control may be a modifiable configuration that manages collection of observability information 412 from program 410. Instrumenting operations 416b may include configuring observability control 420 to be dynamically activated and/or deactivated. Further, instrumenting operations 416b may include configuring observability control 420 to be dynamically modified to adjust the observability information 412 being collected in association with an identified vulnerable portion of program 410.

Once instrumented with observability control 420, the collection, processing, storing, logging, etc. of observability information 412 from program 410 may be subject to dynamic adjustment. For example, by modifying observability control 420, the configuration of observability information 412 collection may be correspondingly modified.

In various embodiments these modifications are based on observability attributes 414. Observability attributes 414 may be a broad term encompassing a variety of attributes of program 410, observability information collected from program 410, external threat intelligence, etc. that is dynamically updated and/or obtained. For instance, the observability attributes 414 may include attributes associated with the collection of observability information from program 410.

In various embodiments, observability information 412 collected from program 410 may be dynamically included among observability attributes 414. In this manner, a feedback loop may be created where the observability information 412 collected from program 410 is then used to modify observability control 420, which, in turn, may adjust collection of subsequent observability information.

For instance, observability information 412 may be collected from the execution of program 410 according to a configuration specified by observability control 420 such that when observability control 420 for a portion of program 410 is modified so too is the collection of observability information from that portion. For example, a degree (e.g., type, amount, proportion, collection frequency, etc.) of observability information 412 specified by observability control 420 may be collected and/or logged from the execution of program 410. Observability control 420 may be dynamically modified so that the degree of observability information 412 collected from the execution of program 410 is not static and is adjustable based on observability attributes 414 and/or new or updated inputs 402. Again, the modification of observability control 420 may be a result of a feedback loop where observability information 412 from a first collection of observability information 412 serves as the basis for a subsequent modification to observability control 420 that adjusts subsequent collections of observability information.

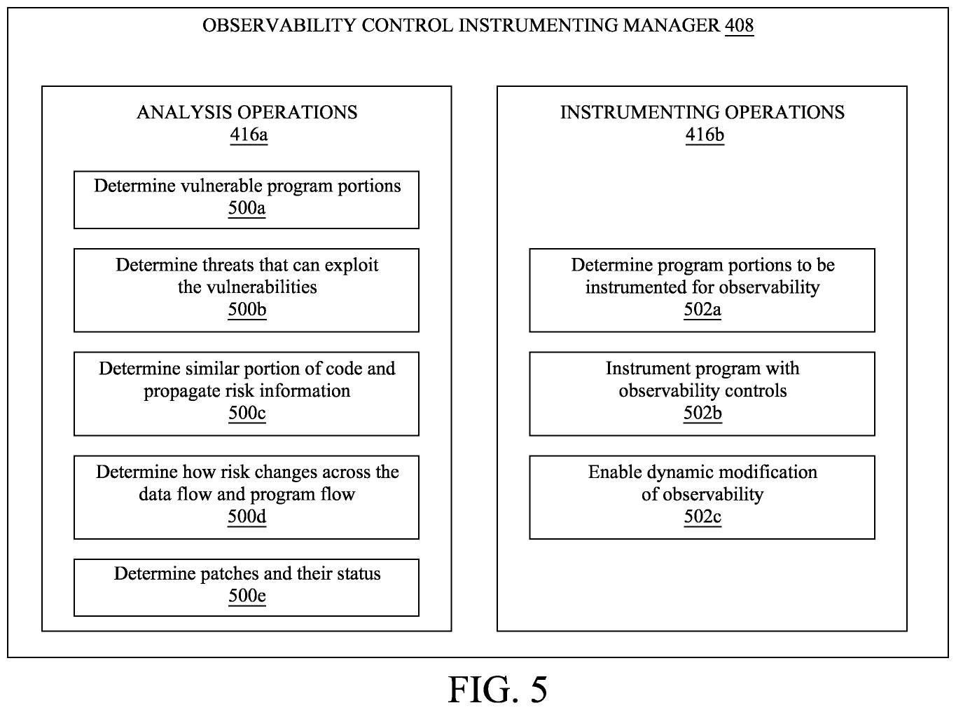

FIG. 5 illustrates example operations for instrumenting observability controls by observability control instrumenting manager 408, according to various embodiments. Observability control instrumenting manager 408 may instrument a program with dynamically modifiable observability controls via analysis operations 416a and/or instrumenting operations 416b. Analysis operations 416a and/or instrumenting operations 416b may be performed by a processing resource one or more computing devices (e.g., standalone computing devices, servers, distributed and/or cloud-based computing resources, etc.) that executes the subject program and/or by a processing resource of one or more computing devices that do not execute the subject program.

Analysis operations 416a may include various operations 500 associated with analyzing inputs to generate vulnerability and risk assessments of a subject program. For example, first analysis operation 500a may include determining vulnerable portions of a program such as vulnerable points, vulnerable segments, vulnerable APIs, vulnerable functions, vulnerable data flows, vulnerable control flow paths.

Determining vulnerable portions of the program may include analyzing the code of the various portions of program for potential vulnerabilities. The vulnerabilities may be identified based on inputs such as security vulnerability information, security vulnerability risks, security vulnerability analytics etc. associated with known vulnerabilities. For example, various catalogs identifying known vulnerabilities may be obtained as inputs and/or relied upon to identify similar vulnerabilities in a subject program.

In various embodiments, a common weakness enumeration (CWE) of known software and/or hardware weakness types may be used as a reference or comparison tool in scanning the code of the program. In another example, a common vulnerabilities and exposures (CVE) system providing a reference for known information-security vulnerabilities and exposures of various systems and products may be used as a reference or comparison tool in scanning the code of the program.

Therefore, first analysis operation 500a may use the various inputs that provide observability control instrumenting manager 408 with knowledge of known vulnerabilities existing in other programs. Observability control instrumenting manager 408 may use this knowledge to analyze the code of a subject program and identify portions of the program where potentially the same or similar vulnerabilities may exist. For example, observability control instrumenting manager 408 may look for portions of a subject program that match examples with known vulnerabilities.

In addition, the various inputs may include inputs that provide observability control instrumenting manager 408 with knowledge of known vulnerabilities of the subject program. For example, an input may include analytics, reports, test results, etc. that reveal one or more instances of a vulnerability such as an incorrect key generation in association with execution of a particular portion of the subject program. In such instances, first analysis operation 500a may include identifying other portions of the subject program that are identical to and/or function similarly to the particular portion having been identified as vulnerable.

Second analysis operation 500b may include determining threats that can exploit the identified vulnerabilities. For example, an exploit and/or known threats for a particular attack vector may be identified for each vulnerable portion of the program. In some examples, this may include identifying a risk level associated with each of the threats. For instance, a risk level for a threat may be identified based on its prevalence, chances for success, chances to damage the operation of the program, chances of compromising sensitive data (personally identifiable information, private data, account data, financial data, medical data, secret/confidential data, etc.), etc.

Third analysis operation 500c may include determining similar portions of code in the program and/or propagating risk information. For instance, when first analysis operation 500a identifies a potentially vulnerable portion of code based on known vulnerabilities and/or second analysis operation 500b associates that potentially vulnerable portion with a risk assessment of that vulnerability based on known threats, then third analysis operation 500c may include scanning the code of the program to identify a similar portion of code that may share that same vulnerability, flagging it as vulnerable, and associating the risk assessment with that portion as well. This scanning operation may include a comparison operation comparing identifying information of the vulnerability to code of the program and searching for a match.

Fourth analysis operation 500d may include determining how risk changes across the data flow and program flow. For example, fourth analysis operation 500d may include analyzing vulnerabilities and/or their exploitation risk across control flows, program flows, data flows etc. By analyzing the flow of data (e.g., from, to, between, etc.) potentially vulnerable portions of the program and/or similar portions of the program, fourth analysis operation 500d may achieve a comprehensive overview of the presence of vulnerabilities in the flow of data and/or the risk of those vulnerabilities in an executing program. Identifying vulnerabilities in the flows, therefore, adds an additional level of vulnerability identification over scanning library binary and/or source code binary alone.

Fifth analysis operation 500e may include determining any patches that exist for identified potential vulnerabilities of the program. These may be patches that have been implemented in the program or patches that have yet to be implemented in the program. Fifth analysis operation 500e may also include determining a testing and/or implementation status of the known patches. The status may include how effective the patch has been shown to be against a threat, how much testing the patch has underwent, whether the patch is considered stable, etc.

In various embodiments, analysis operations 416a may be executed to generate outputs that identify observable points in the program that are related to known vulnerabilities received in and input and may identify relationship between the observable points based on the vulnerability risks or the code segments. Again, these outputs may be determined based on similar vulnerabilities based on the weakness type (e.g., determined from CVE weaknesses inputs), common vulnerabilities in the programming language used, compiler introduced vulnerabilities, library introduced vulnerabilities, etc. The similarity can also be determined based on the risks they pose, or type of attack vector described for the known input vulnerabilities (e.g., determined from CVE weaknesses inputs).

Instrumenting operations 416b may include various operations 502 associated with instrumenting a subject program with observability controls. For example, first instrumenting operation 502a may include determining program portions to be instrumented for observability. For instance, first instrumenting operation 502a may identify portions of the code where the known or similar vulnerabilities are found and determine whether those portions should be instrumented with observability. In addition, first instrumenting operation 502a may identify the degree of observability with which a vulnerable portion of a program should be initially instrumented.

The determination of whether those portions should be instrumented with observability may be based on one or more of a variety of factors associated with the consequences of a potential vulnerability and/or the consequences of instrumenting portions with those potential vulnerabilities with observability. For instance, the factors may include: the amount of observability information expected to be collected from the portion; the cost (e.g., amount of computational resources, amount of network bandwidth, amount of storage, amount of performance degradation, an amount of money (e.g., to maintain the aforementioned resources), etc.) of data collection, transfer, storage, etc. for that portion; the API cost for that portion; the risk of the vulnerability; the security risk of the vulnerability; the sensitive data exposure risk of the vulnerability; patch information for the vulnerability; software supply chain considerations; and/or various other factors.

Specifically, the determination whether potentially vulnerable portions should be instrumented with observability and/or the degree of observability they should be instrumented with may be selected to optimize among one or more of those various factors. For example, instrumentation with observability may be done in a way that optimizes (e.g., minimizes) storage and performance costs while ensuring that potentially vulnerable portions of the program are instrumented with a degree of observability warranted by the determined risk level of the vulnerability and/or the usefulness of the observability information in assessing the vulnerable portion of the program.

For example, security vulnerability information, risks, analytics, etc. may be determined by CVE, CWE, program analysis, call-graph analysis, etc. and if the risk for a particular vulnerable portion is low, then that portion may be instrumented with an observability component configured to generate a relatively reduced logging-level (e.g., collecting less observability information) for that portion. In contrast, if the risk for the particular vulnerable portion is high, then that portion may be instrumented with an observability component configured to generate a relatively increased logging-level (e.g., collecting more observability information) for that portion.

First instrumenting operation 502a may include instrumenting the program (e.g., library binaries associated with the program, program source code/binaries, APIs associated with the program, data flows associated with the program, control flows associated with the program, etc.) with observability components. The observability components may be executable to collect observability information from the execution of the various vulnerable portions of the program according to their configuration. As such, first instrumenting operation 502a may include instrumenting observability components in the code in, around, and/or associated with the portions of the program where the vulnerabilities were identified to cause the collection of observability information from those portions.

Second instrumenting operation 502b may include instrumenting the program (e.g., library binaries associated with the program, program source code/binaries, APIs associated with the program, data flows associated with the program, control flows associated with the program, etc.) with observability controls to manage the collection of observability information from the execution of the various vulnerable portions of the program. For example, instrumented observability controls may configure the collection of observability information by observability components. Instrumenting the program may include instrumenting the code in, around, and/or associated with the portions of the program where the potential vulnerabilities are identified and/or in, around, and/or associated with the observability components instrumented for collecting observability information from those potentially vulnerable portions.

Second instrumenting operation 502b may also include determining which potentially vulnerable portions of the program are to be instrumented with the observability controls. This determination may be based on a variety of factors associated with the consequences of a potential vulnerability and/or the consequences of instrumenting portions with those potential vulnerabilities with observability. For example, the determination of which potentially vulnerable portions to instrument may be based on one or more factors such as the amount of observability information expected to be collected from the portion, the cost (e.g., amount of computational resources, amount of network bandwidth, amount of storage, amount of performance degradation or improvement, an amount of money (e.g., to maintain the aforementioned resources), etc.) of data collection, transfer, storage, etc. for that portion, the API cost for that portion, the risk of the vulnerability, the security risk of the vulnerability, the sensitive data exposure risk of the vulnerability, patch information for the vulnerability, software supply chain considerations, and/or various other factors.

Third instrumenting operation 502c may include enabling dynamic modifications to the collection of observability information. Enabling dynamic modifications may include enabling mechanisms to change an activation status of an observability control managing the collection of the observability information for a potentially vulnerable portion of the program.

Changing an activation status of an observability control may include activating or deactivating the observability control. When the observability control is active, it may be used to configure observability of the vulnerable portions of the program. When the observability control in inactive, it may not be used to configure observability of the vulnerable portions of the program. In instances where the observability control is inactive, observability of the vulnerable portions may be discontinued or may proceed as it would in the absence of observability controls to modify the collection of observability information.

The activation or deactivation may be done dynamically and in response to detecting various observability attributes. For example, an observability control may be activated or deactivated based on one or more of a variety of factors associated with the consequences of a potential vulnerability and/or the consequences of instrumenting portions with those potential vulnerabilities with observability. For example, the activation status of an observability control associated with to potentially vulnerable portion of the program may be based on one of more factors such as the amount of observability information expected to be collected from the portion, the cost (e.g., amount of computational resources, amount of network bandwidth, amount of storage, amount of performance degradation or improvement, an amount of money (e.g., to maintain the aforementioned resources) etc.) of data collection, transfer, storage, etc. for that portion, the amount of observability information already logged for that portion, the API cost for that portion, the risk of the vulnerability, the security risk of the vulnerability, the sensitive data exposure risk of the vulnerability, patch information for the vulnerability, software supply chain considerations, a policy outlining where and/or when to activate or deactivate an observability control, and/or various other factors.

Third instrumenting operation 502c may also include enabling dynamic modification of the degree of observability information collected from vulnerable portions of the program. For example, an observability control may be activated so that it can be dynamically modified in response to detecting various observability attributes. These modifications may result in a modification to the degree of observability information that is collected for a corresponding vulnerable portion of the program.

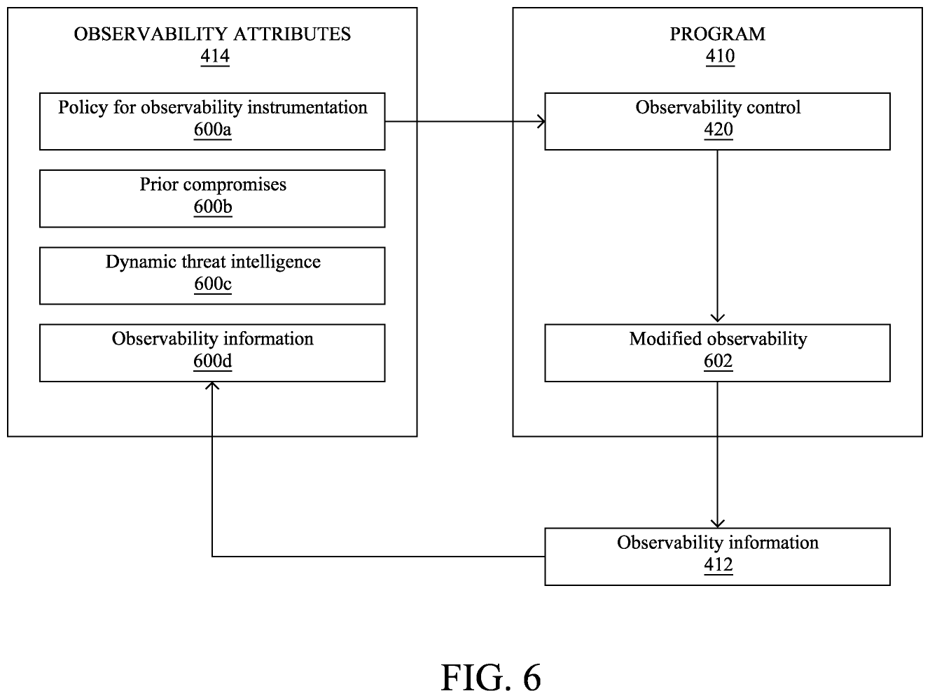

FIG. 6 illustrates example operations of observability attributes 414 that may be utilized for modifying observability control 420, according to various embodiments. As described above, an observability control 420 may include an observability information collection configuration that is applicable to an observability component responsible for managing observability information collection, transfer, logging, etc. from a potentially vulnerable portion of a program. Since observability control 420 may, when active, may manage the configuration of observability components of program 410, a modification to an observability control 420 may result in modified observability 602 over a previous configuration. For example, a modification to observability control 420 may adjust the degree of observability information 412 collected from a corresponding vulnerable portion of the program.

A modification to an observability control may occur based on observability attributes 414. A first observability attribute 600a may include policy information for observability instrumentation. The policy information may include one or more policies for the program specifying where and/or when to activate or de-activate observability control 420. In addition, the policies may specify what degree of observability should be performed. The policies may specify attributes and/or attribute levels (e.g., risk, vulnerability, weakness, log-level, etc.) that should trigger the activation, de-activation, degree of observability, etc.

Second observability attribute 600b may include prior compromises. Prior compromises may include prior compromises of the subject program or other similar programs (e.g., programs developed by the same or similar developers, programs of a same type, programs having similar portions of code, etc.). The compromises may include exploitations of vulnerable portions of code.

Third observability attribute 600c may include dynamic threat intelligence. Dynamic threat intelligence may include threat (e.g., vulnerabilities, attack vectors, exploits, malicious attacks, etc.) history data that can be utilized to proactively block and/or remediate future malicious attacks on a program. For example, dynamic threat intelligence may include information about known threats including their properties and/or the properties of the attack vectors that they exploit. In some instances, the dynamic threat intelligence may indicate a risk level associated with threats. The risk level may include a characterization of a success rate of an exploit, a consequence of a successful exploit, the damage potentially caused by an exploit, the cost of remediating an exploit, etc. The dynamic threat intelligence may be dynamically updated to reflect the most up-to-date knowledge on threats.

Fourth observability attribute 600d may include observability information 412. Observability information 412 may include data such as metrics, events, logs, traces, etc. collected from execution of the potentially vulnerable portions of program 410 as configured by observability control 420. The observability information 412 may be collected, transferred, stored, logged, etc. by observability components instrumented in program 410. The observability information 412 may logged and labeled with indications of its vulnerability, risk, and/or data sensitivity.

Observability information 412 may also include information about the metrics, events, logs, traces, etc. collected from execution of the vulnerable portions of program 410 and/or the collection, transferring, storing, logging, etc. of that data. For instance, observability information 412 may include a determination whether the data being collected from the execution of a vulnerable portion of the program 410 is increasing a risk of a security and/or privacy breach or not meeting privacy requirements. For example, where the data being collected from the execution of a vulnerable portion of the program 410 is sensitive data, a determination may be made that its collection is increasing the risk of a security or privacy breach since the sensitive data is being collected and logged. In addition, observability information may include how much data is being logged from the execution of the vulnerable portion of program 410, current log levels, a cost associated with logging the data from the execution of the vulnerable portion of program 410, etc.

The observability information 412 collected from execution of the potentially vulnerable portions of program 410 may incorporated into a feedback loop. For example, observability information 412 may be used as an observability attribute (e.g., fourth observability attribute 600d) that can be used to modify observability control 420 of program 410. As a result, a feedback loop may be created where the observability information collected for a vulnerable portion of program 410 can modify observability control 420 and, consequently, modify subsequent collections of observability information from the vulnerable portion (e.g., modified observability 602).

In various embodiments, observability attributes 414 may be used to modify observability control 420. For example, observability control 420 may be activated, deactivated, reconfigured to cause a different degree of collection of observability information 412, etc. in response to encountering various observability attributes 414 and/or those observability attributes meeting or exceeding various threshold levels. In some instances, the modifications to observability control 420 may be informed by and/or based on the policies for observability instrumentation, such as those described above with respect to first observability attribute 600a. For example, a policy may outline where and/or when to activate, de-activate, adjust a degree of observability information collection by observability control 420 in response to various levels of risk, vulnerabilities, weakness, log-levels, cost of logging, etc.

For instance, observability attributes 414 can reveal the amount of observability information expected to be collected from the potentially vulnerable portion, the cost (e.g., amount of computational resources, amount of network bandwidth, amount of storage, amount of performance degradation or improvement, an amount of money (e.g., to maintain the aforementioned resources), etc.) of data collection, transfer, storage, etc. for that portion, the amount of observability information already logged for that portion, the API cost for that portion, the risk of the vulnerability, the security risk of the vulnerability, the sensitive data exposure risk of the vulnerability, patch information for the vulnerability, software supply chain considerations, a security and/or privacy risk represented by collecting and/or logging particular types of observability information, a policy outlining where and/or when to activate or deactivate an observability control, and/or various other attributes. Since modifying the observability control 420 on the basis of these attributes results in modified observability 602 (initiating collection of observability information 412, discontinuing collection of observability information 412, modifying a degree of observability information collected, etc.) for a vulnerable portion of program 410, the collection and/or degree of collection of observability information 412 may be dynamically adapted to prevailing conditions such as those revealed by the observability attributes.

Therefore, the collection of observability information 412 can be activated/deactivated and/or the degree of collection of observability information 412 from vulnerable portions of program 410 can be dynamically adapted to respond to at least one of a variety of factors such as cost concerns, risk levels, types of vulnerabilities, etc. dynamically revealed through observability attributes 414. In various embodiments, this adaptation can occur in substantially real-time so that observability scales with a real-time assessment of a threat level posed by a vulnerability and countervailing considerations.

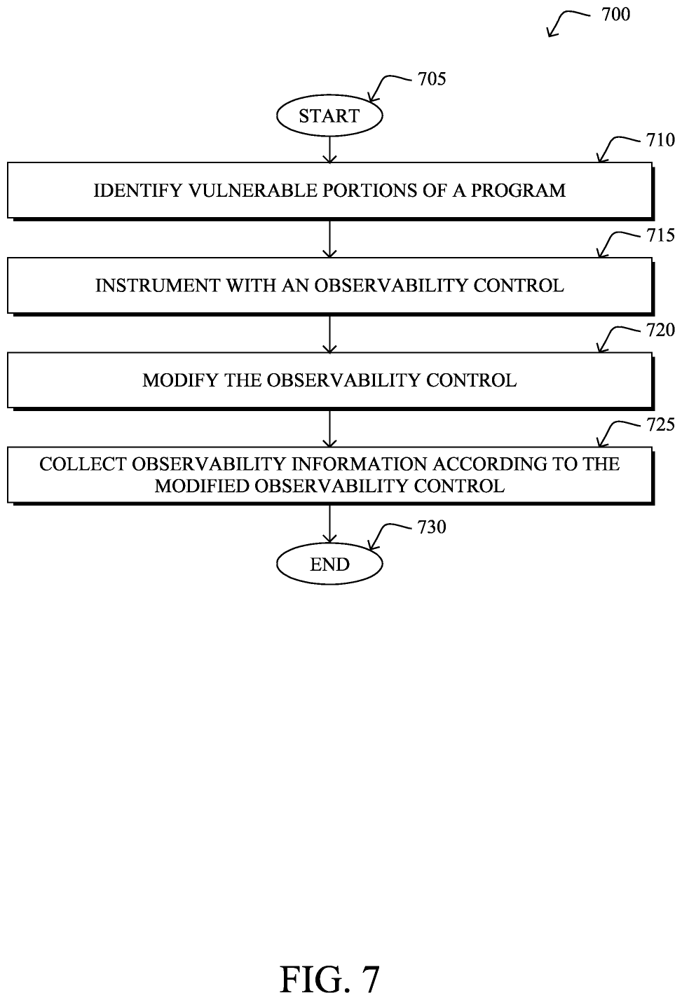

In closing, FIG. 7 illustrates an example simplified procedure for instrumenting observability controls in accordance with one or more embodiments described herein. For example, a non-generic, specifically configured device (e.g., device 200, particularly an observability management device) may perform procedure 700 by executing stored instructions (e.g., process 248, such as observability control process). The procedure 700 may start at step 705, and continues to step 710, where, as described in greater detail above, a device may identify one or more vulnerable portions of a program to be observed. The identification may be based on security vulnerability information. Identifying the one or more vulnerable portions of the program to be observed based on the security vulnerability information may include analyzing code of the program and/or identifying the one or more vulnerable portions of the program based on their similarity to known vulnerabilities. In some embodiments, Vulnerable code segments, vulnerable components of a system, vulnerable communication paths may be determined from other mechanisms and may be specified as a configuration or as part of a dynamically updated list.

At step 715, as detailed above, the device may instrument the program with an observability control. Instrumenting the program with the observability control may include at least one of modifying binary of the program to include the observability control, modifying binary of libraries associated with the program to include the observability control, and combinations thereof. Additionally, instrumenting the program with the observability control may include instrumenting a data flow involving the one or more vulnerable portions of the program, instrumenting a control flow path to report its flow involving the one or more vulnerable portions of the program, and combinations thereof. The observability control may be used to configure collection of observability information regarding the one or more vulnerable portions of the program. In some examples, the device may take a dynamically updated list or configuration specifying vulnerable code segments, vulnerable components of a system, vulnerable communication paths as an input and provide the instrumentation of the system for observability of the vulnerable components or to reduce observability when vulnerable channels or components are used for collection of observability data.

At step 720, as detailed above, the device may modify the observability control. Modifying the observability control may include changing an activation status of the observability control. When the observability control is active, it may be used to configure observability of the vulnerable portions of the program. When the observability control in inactive, it may not be used to configure observability of the vulnerable portions of the program. In instances where the observability control is inactive, observability of the vulnerable portions may be discontinued or may proceed as it would in the absence of observability controls to modify the collection of observability information. In some examples, modifying the observability control may include changing a degree of the observability information associated with the one or more vulnerable portions of the program that is collected. In further examples, modifying the observability control may include reducing collection of the observability information regarding the one or more vulnerable portions of the program when the one or more vulnerable portions of the program are used for collection of observability data

The modifications to the observability controls may be based on one or more attributes associated with collecting the observability information. The one or more attributes associated with collecting the observability information may include a risk level associated with the one or more vulnerable portions of the program. In some embodiments, the one or more attributes associated with collecting the observability information may include a type of a vulnerability of the one or more vulnerable portions of the program.

Additionally, the one or more attributes associated with collecting the observability information may include an amount of the observability information associated with the one or more vulnerable portions of the program. In various embodiments, the one or more attributes associated with collecting the observability information may include a cost of collecting the observability information. The one or more attributes associated with collecting the observability information may also include a patch available for the one or more vulnerable portions of the program.

At step 725, as detailed above, the device may collect the observability information associated with the one or more vulnerable portions of the program. The collection may proceed according to the observability control as modified.

The simplified procedure 700 may then end in step 730, notably with the ability to continue modifying the observability control based on additional attributes associated with colleting observability information from the vulnerable portions of the program and adapting collection of the observability information from those portions to the attributes. Other steps may also be included generally within procedure 700. For example, such steps (or, more generally, such additions to steps already specifically illustrated above), may include: using the observability information regarding the one or more vulnerable portions of the program collected in a first collection operation to additionally modify the observability control and collect the observability information regarding the one or more vulnerable portions of the program according to the observability control as additionally modified; and so on.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for instrumenting observability controls. In particular, the techniques herein provide a mechanism for leveraging information about known vulnerabilities to search for and/or identify potentially unknown vulnerabilities in the code that are similar to the known ones. The techniques involve dynamically sourcing data to provide cutting edge vulnerability assessments of programs. Moving well beyond matching code to known vulnerabilities, these techniques combine a mechanism for intelligent assessment of a program's vulnerabilities that can not only identify ‘hot spots” (e.g., vulnerable portions of a program) with a mechanism that leverages this intelligence to then dynamically instrument those ‘hot spots’ with observability controls that allow for the dynamic adaptation of observability information collection from those ‘hot spots.’ In general, these techniques provide for an intelligent and adaptable program surveillance platform that can balance countervailing concerns, such as data logging costs with vulnerability risk level, in a manner that adapts to the most recent threat intelligence and observations from the vulnerable portions of the program.

According to the embodiments herein, an illustrative method herein may comprise: identifying, by a device, one or more vulnerable portions of a program to be observed based on security vulnerability information; instrumenting, by the device, the program with an observability control to configure collecting of observability information regarding the one or more vulnerable portions of the program; modifying, by the device, the observability control based on one or more attributes associated with the collecting of the observability information regarding the one or more vulnerable portions of the program; and collecting, by the device, the observability information regarding the one or more vulnerable portions of the program according to the observability control as modified.

In one embodiment, modifying the observability control includes changing an activation state of the observability control. In another embodiment, modifying the observability control includes changing a degree of the observability information associated with the one or more vulnerable portions of the program that is collected. In a further embodiment, the one or more attributes associated with collecting the observability information include a risk level associated with the one or more vulnerable portions of the program. In a still further embodiment, the one or more attributes of the one or more vulnerable portions of the program include a type of a vulnerability of the one or more vulnerable portions of the program.

In one embodiment, the one or more attributes of the one or more vulnerable portions of the program include an amount of the observability information associated with the one or more vulnerable portions of the program. In another embodiment, the one or more attributes of the one or more vulnerable portions of the program include a cost of collecting the observability information. In a further embodiment, the one or more attributes of the one or more vulnerable portions of the program include a patch available for the one or more vulnerable portions of the program. In a still further embodiment, identifying the one or more vulnerable portions of the program to be observed based on the security vulnerability information further comprises: analyzing code of the program; and identifying the one or more vulnerable portions of the program based on their similarity to known vulnerabilities.

In an additional embodiment, instrumenting the program with the observability control to collect observability information regarding the one or more vulnerable portions of the program includes at least one of modifying binary of the program to include the observability control, modifying binary of libraries associated with the program to include the observability control, instrumenting a data flow involving the one or more vulnerable portions of the program, instrumenting a control flow path to report its flow involving the one or more vulnerable portions of the program, and combinations thereof. In a further embodiment, modifying the observability control includes reducing collection of the observability information regarding the one or more vulnerable portions of the program when the one or more vulnerable portions of the program are used for collection of observability data.

According to the embodiments herein, an illustrative tangible, non-transitory, computer-readable medium herein may have computer-executable instructions stored thereon that, when executed by a processor on a computer, may cause the computer to perform a method comprising: identifying one or more vulnerable portions of a program to be observed based on security vulnerability information; instrumenting the program with an observability control to configure collecting of observability information regarding the one or more vulnerable portions of the program; modifying the observability control based on one or more attributes associated with the collecting of the observability information regarding the one or more vulnerable portions of the program; and collecting the observability information regarding the one or more vulnerable portions of the program according to the observability control as modified.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: identify one or more vulnerable portions of a program to be observed based on security vulnerability information; instrument the program with an observability control to configure collecting of observability information regarding the one or more vulnerable portions of the program; modify the observability control based on one or more attributes associated with the collecting of the observability information regarding the one or more vulnerable portions of the program; and collect the observability information regarding the one or more vulnerable portions of the program according to the observability control as modified.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by an observability control instrumenting manager”, those skilled in the art will appreciate that agents of the observability control instrumenting platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
identifying, by a device, one or more vulnerable portions of a program to be observed based on security vulnerability information;
instrumenting, by the device, the program with an observability control to configure collecting of observability information regarding the one or more vulnerable portions of the program;
modifying, by the device, the observability control based on one or more attributes associated with the collecting of the observability information regarding the one or more vulnerable portions of the program; and
collecting, by the device, the observability information regarding the one or more vulnerable portions of the program according to the observability control as modified.

2. The method as in claim 1, wherein modifying the observability control includes changing an activation state of the observability control.

3. The method as in claim 1, wherein modifying the observability control includes changing a degree of the observability information associated with the one or more vulnerable portions of the program that is collected.

4. The method as in claim 1, wherein the one or more attributes associated with collecting the observability information include a risk level associated with the one or more vulnerable portions of the program.

5. The method as in claim 1, wherein the one or more attributes of the one or more vulnerable portions of the program include a type of a vulnerability of the one or more vulnerable portions of the program.

6. The method as in claim 1, wherein the one or more attributes of the one or more vulnerable portions of the program include an amount of the observability information associated with the one or more vulnerable portions of the program.

7. The method as in claim 1, wherein the one or more attributes of the one or more vulnerable portions of the program include a cost of collecting the observability information.

8. The method as in claim 1, wherein the one or more attributes of the one or more vulnerable portions of the program include a patch available for the one or more vulnerable portions of the program.

9. The method as in claim 1, wherein identifying the one or more vulnerable portions of the program to be observed based on the security vulnerability information further comprises:
analyzing code of the program; and
identifying the one or more vulnerable portions of the program based on their similarity to known vulnerabilities.

10. The method as in claim 1, wherein instrumenting the program with the observability control to collect observability information regarding the one or more vulnerable portions of the program includes at least one of modifying binary of the program to include the observability control, modifying binary of libraries associated with the program to include the observability control, instrumenting a data flow involving the one or more vulnerable portions of the program, instrumenting a control flow path to report its flow involving the one or more vulnerable portions of the program, and combinations thereof.

11. The method as in claim 1, wherein modifying the observability control includes reducing collection of the observability information regarding the one or more vulnerable portions of the program when the one or more vulnerable portions of the program are used for collection of observability data.

12. A tangible, non-transitory, computer-readable medium having computer-executable instructions stored thereon that, when executed by a processor on a computer, cause the computer to perform a method comprising:
identifying one or more vulnerable portions of a program to be observed based on security vulnerability information;
instrumenting the program with an observability control to configure collecting of observability information regarding the one or more vulnerable portions of the program;
modifying the observability control based on one or more attributes associated with the collecting of the observability information regarding the one or more vulnerable portions of the program; and
collecting the observability information regarding the one or more vulnerable portions of the program according to the observability control as modified.

13. The tangible, non-transitory, computer-readable medium as in claim 12, wherein modifying the observability control includes changing an activation state of the observability control.

14. The tangible, non-transitory, computer-readable medium as in claim 12, wherein modifying the observability control includes changing a degree of the observability information associated with the one or more vulnerable portions of the program that is collected.

15. The tangible, non-transitory, computer-readable medium as in claim 12, wherein the one or more attributes associated with collecting the observability information include a risk level associated with the one or more vulnerable portions of the program.

16. The tangible, non-transitory, computer-readable medium as in claim 12, wherein the one or more attributes of the one or more vulnerable portions of the program include a type of a vulnerability of the one or more vulnerable portions of the program.

17. The tangible, non-transitory, computer-readable medium as in claim 12, wherein the one or more attributes of the one or more vulnerable portions of the program include an amount of the observability information associated with the one or more vulnerable portions of the program.

18. The tangible, non-transitory, computer-readable medium as in claim 12, wherein the one or more attributes of the one or more vulnerable portions of the program include a cost of collecting the observability information.

19. The tangible, non-transitory, computer-readable medium as in claim 12, wherein the one or more attributes of the one or more vulnerable portions of the program include a patch available for the one or more vulnerable portions of the program.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
identify one or more vulnerable portions of a program to be observed based on security vulnerability information;
instrument the program with an observability control to configure collecting of observability information regarding the one or more vulnerable portions of the program;
modify the observability control based on one or more attributes associated with the collecting of the observability information regarding the one or more vulnerable portions of the program; and
collect the observability information regarding the one or more vulnerable portions of the program according to the observability control as modified.
